(19) United States
(12) Patent Application Publication
(10) Pub. No.: US 2011/0126790 A1
(43) Pub. Date: Jun. 2, 2011

(54) Battery Powered Electric Starter

(76) Inventor: Neil Vacek, Washington, IL (US)

(21) Appl. No.: 12/956,383

(22) Filed: Nov. 30, 2010

Related U.S. Application Data
(60) Provisional application No. 61/266,140, filed on Dec. 2, 2009.

(51) Int. Cl. F02N 11/00

(52) U.S. Cl. 123/179.28

(57) ABSTRACT

An architecture is presented that provides an electric starter device. The electric starter device allows a user to start any two cycle/two stroke engine, such as those used in weed trimmers, leaf blowers, chainsaws, etc. by utilizing a push button starter. The electric starter device comprises an electric motor powered by a battery and an engine crankshaft, wherein a pulley connects the engine crankshaft to the electric motor. Further, an electric starter switch is positioned on the two cycle/two stroke engine, near a start/stop switch for turning on and off the engine and near an engine choke switch for engaging the engine. Furthermore, if the battery is not charged or an electrical failure occurs, a user may start the two cycle/two stroke engine with the pull start device as normal.

### CROSS-REFERENCE

This application claims priority from Provisional Patent Application Ser. No. 61/266,140 filed Dec. 2, 2009.

### BACKGROUND

Currently, most gas fed machines, such as lawn equipment, can be a struggle to start. The manual pull flywheel device is difficult to pull, especially for the weak or elderly. Furthermore, many individuals have pulled a muscle in their arm or back attempting to start the motor. Some have switched to electric devices. However, electric machines do not have as much power as gas fed machines.

Consequently, a need exists for an electric starter device for small engine, gas fed machines. The proposed invention allows for a user to start a traditional small engine, such as a two cycle/two stroke engine with a push button device, and still have the power produced by a gas fed machine. Weak individuals and the elderly may then use this device for powering and starting any two cycle/two stroke engine such as those on weed trimmers, leaf blowers, chainsaws, etc.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises an electric starter device for small engines. The small engines comprise two cycle/two stroke engines. Specifically, the electric starter device allows a user to start any two cycle/two stroke engine, such as those on weed trimmers, leaf blowers, chainsaws, etc. by utilizing a push button starter. The electric starter device comprises an electric motor powered by a battery and an engine crankshaft, wherein a pulley connects the engine crankshaft to the electric motor. Further, an electric starter switch is positioned on the two cycle/two stroke engine, near a start/stop switch for turning on and off the engine and near an engine choke switch for engaging the engine.

Furthermore in the preferred embodiment of the present invention, the electric starter device is used to supplement a traditional engine pull start device. The engine pull start device is not removed when the electric starter device is added to the two cycle/two stroke engine. For example, the rechargeable battery powers the electric motor and enables a user to start the engine with the push of a button. However, if the battery is not charged or there is an electrical failure, a user may start the engine with the pull start device as normal.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of an electric starter device installed on a two cycle/two stroke engine.

FIG. 2 illustrates a perspective view of the electric starter device wherein a battery housing is attached to the two cycle/two stroke engine.

FIG. 3 illustrates a perspective view of the electric starter device installed on a weed trimmer.

FIG. 4 illustrates a perspective view of the electric starter device installed on a chainsaw.

FIG. 5 illustrates a perspective view of the electric starter device installed on a leaf blower.

FIG. 6 illustrates a perspective view of a user using a weed trimmer with the electric starter device installed.

FIG. 7 illustrates a method of powering and starting a two cycle/two stroke engine with an electric starter device.

FIG. 8 illustrates further aspects in the powering and starting method of FIG. 7.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

Typically, most gas fed machines, such as lawn equipment, can be a struggle to start. The manual pull flywheel device is difficult to pull, especially for the weak or elderly. Many individuals have pulled a muscle in their arm or back attempting to start the motor. Some have switched to electric devices. However, electric machines do not have as much power as gas fed machines. An electric starter device for gas fed machines would allow the weak or elderly to start a traditional two cycle/two stroke engine, and still have the power produced by a gas fed machine.

Accordingly, the disclosed electric starter device allows for a user to start a two cycle/two stroke engine with a push of a button. The electric starter device is installed on any two cycle/two stroke engine, such as weed trimmers, chainsaws, leaf blowers, etc. The rechargeable battery enables users to start the machine with the push of a button. If the battery is not charged or there is an electrical failure, the user may start the machine with the pull start as normal.

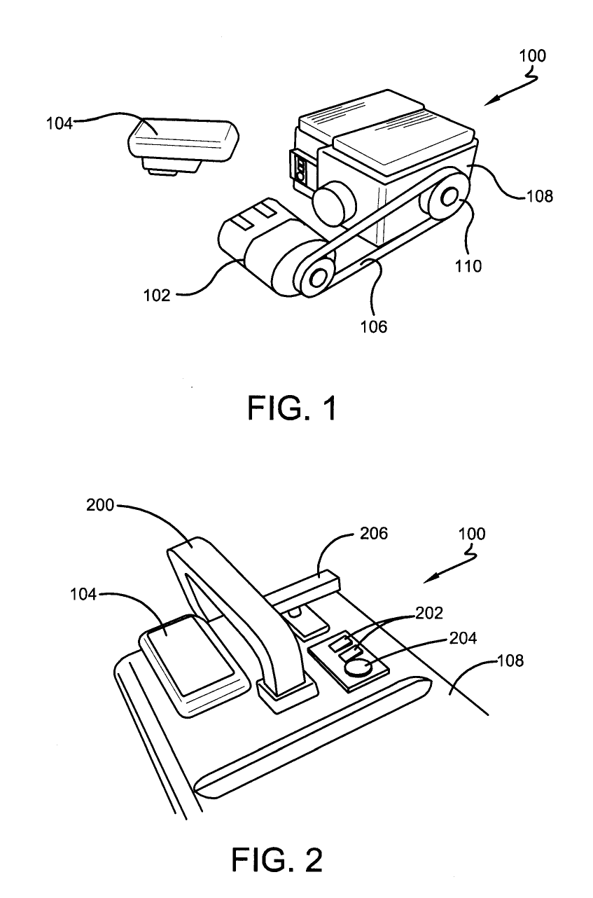

Referring initially to the drawings, FIG. 1 illustrates an electric starter device 100 for small engines. The small engines comprise two cycle/two stroke engines, such as weed trimmers, leaf blowers, chainsaws, etc. The electric starter device 100 comprises an electric motor 102 powered by a battery 104. The battery 104 is typically a rechargeable battery and is secured within a housing. The battery 104 resembles a drill battery. The battery 104 is typically located at a lower handle of the engine 108 to distribute weight.

Furthermore, the electric motor 102 is connected to the two cycle/two stroke engine 108 by a motor mount. The two cycle/two stroke engine 108 also comprises an engine crankshaft 110 which is connected to the electric motor 102 by a pulley 106. The pulley 106 is typically a belt or chain but could be any suitable material for securing the engine crankshaft 110 to the electric motor 102. A start/stop switch (not shown) for turning on and off the engine 108 is located on the engine 108. Additionally, the engine 108 comprises an engine choke switch (not shown) for engaging the engine 108. The electric starter switch (not shown) is typically positioned on the engine 108 below the start/stop switch beside a throttle lever (not shown).

Additionally, the pull start system is still used and enabled along with the electric starter device 100 and is not removed when the electric starter switch is added to the engine. The electric starter device 100 is used to supplement, but not replace the traditional engine pull start device. For example, the rechargeable battery powers the electric motor and enables a user to start the engine with the push of a button. However, if the battery is not charged or there is an electrical failure, a user may start the engine with the pull start device as normal. The pull start device (not shown) would be engaged by a clutch drive and then utilized to start the engine 108.

FIG. 2 illustrates the electric starter device 100 wherein a battery and housing 104 is attached to the two cycle/two stroke engine 108. The battery 104 is located at a lower handle 200 of the engine 108. However, the battery 104 could be located at any suitable place on the engine 108, as long as it distributed weight. Further, a start/stop switch 202 for turning on and off the engine 108 is located on the engine 108. The start/stop switch 202 turns on and off the engine 108. Additionally, the engine 108 comprises an engine choke switch (not shown) for engaging the engine 108. And, the electric starter switch 204 is positioned on the engine 108 below the start/stop switch 202 beside a throttle lever 206. The electric starter device 100 allows a user to start any two cycle/two stroke engine, such as those on weed trimmers, leaf blowers, chainsaws, etc. by utilizing a push button starter (i.e., the electric starter switch 204).

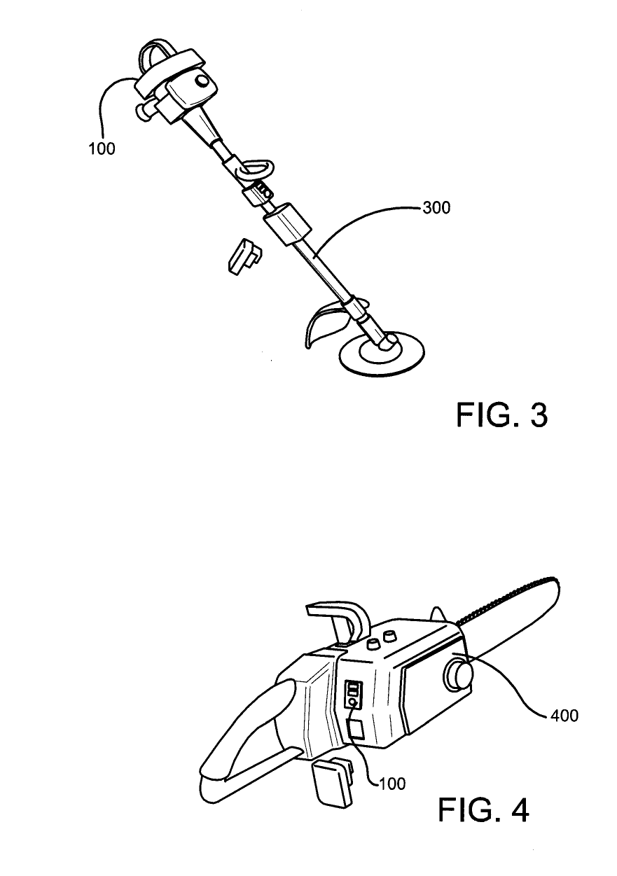

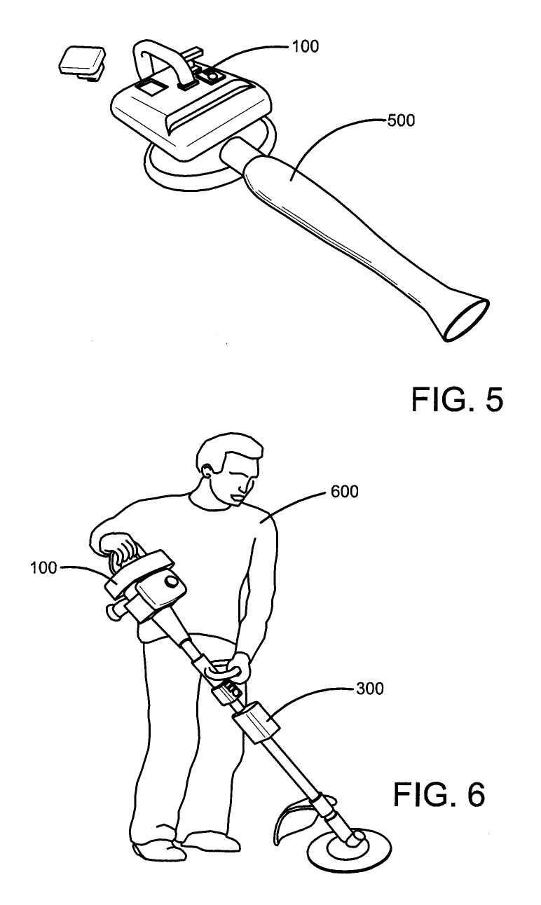

Furthermore, FIGS. 3-6 illustrate the electric starter device 100 in use. FIG. 3 illustrates the electric starter device 100 installed on a weed trimmer 300. FIG. 4 illustrates the electric starter device 100 installed on a chainsaw 400. FIG. 5 illustrates the electric starter device 100 installed on a leaf blower 500. FIG. 6 illustrates a user 600 using a weed trimmer 300 with the electric starter device 100 installed.

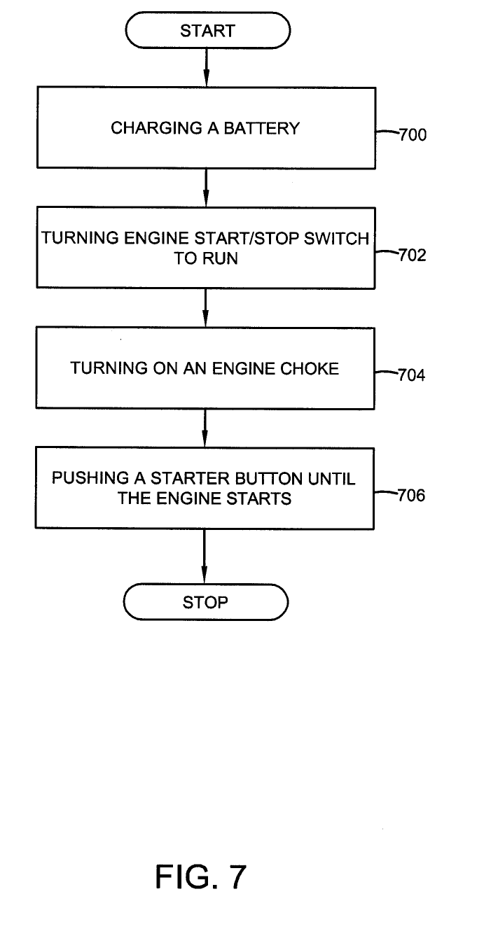

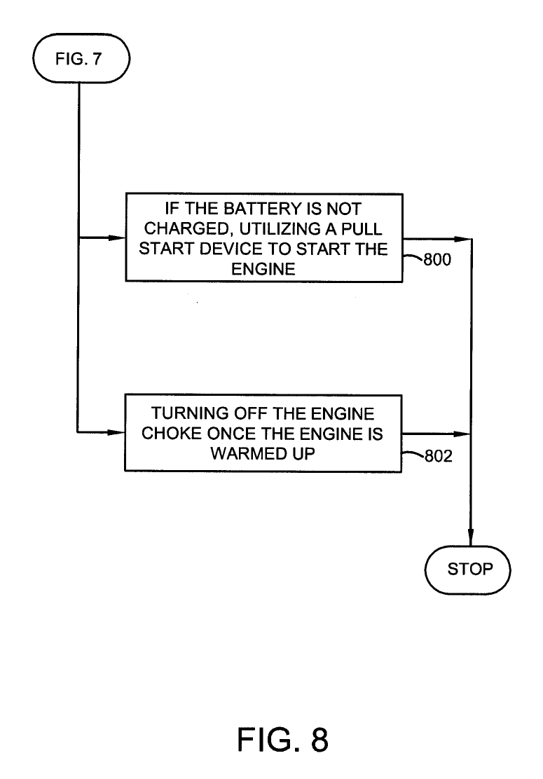

FIGS. 7-8 illustrate methodologies of powering and starting a two cycle/two stroke engine with an electric starter, according to various aspects of the innovation. While, for purposes of simplicity of explanation, the one or more methodologies shown herein (e.g., in the form of a flow chart or flow diagram) are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

Referring to FIG. 7, a method of powering and starting a two cycle/two stroke engine with an electric starter is illustrated. At 700, the battery is charged. The electric motor is powered by a rechargeable battery that resembles a drill battery. The battery is typically secured within a housing. The battery is typically located at a lower handle of the engine to distribute weight. At 702, the engine start/stop switch is turned to run. The engine start/stop switch turns the engine power on and off and allows power to travel to the sparkplugs. At 704, an engine choke is turned on. The engine choke engages the engine and allows fuel to flow to the engine. And, at 706, the electric starter switch is pushed until the engine starts. The electric starter switch turns the electric motor which turns the engine crankshaft connected to the engine.

FIG. 8 illustrates further aspects in the powering and starting method of FIG. 7. At 800, if the battery is not charged, a pull start device is utilized to start the engine. The pull start system is still used and enabled along with the electric starter switch and is not removed when the electric starter switch is added to the engine. The electric starter switch is used to supplement, but not replace the traditional engine pull start device. For example, the rechargeable battery powers the electric motor and enables a user to start the engine with the push of a button (i.e., the electric starter switch). However, if the battery is not charged or there is an electrical failure, a user may start the engine with the pull start device as normal. The pull start device would be engaged by a clutch drive and then utilized to start the engine.

And, at 802, once the engine is warmed up, the engine choke is turned off. The engine choke is turned off to stop the flow of fuel to the engine to avoid flooding the engine. A user would then utilize the throttle to control the amount of fuel to the engine.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An electric starter device for small engines comprising:
an electric motor powered by a battery;
an engine crankshaft, wherein a pulley connects the engine crankshaft to the electric motor;
an electric starter switch positioned on an engine;
a start/stop switch for turning on and off the engine; and
an engine choke switch for engaging the engine.

2. The electric starter device of claim 1, wherein the small engines comprise two cycle/two stroke engines, such as those used in weed trimmers, leaf blowers, or chainsaws.

3. The electric starter device of claim 2, wherein the electric starter switch is located next to the start/stop switch beside a throttle lever.

4. The electric starter device of claim 3, further comprising a pull start device engaged by a clutch drive.

5. The electric starter device of claim 4, further comprising a housing for containing the battery.

6. The electric starter device of claim 5, wherein the battery is rechargeable.

7. The electric starter device of claim 6, wherein the rechargeable battery housing is attached at a lower handle of the engine.

8. The electric starter device of claim 1, wherein the pulley is a belt or chain.

9. The electric starter device of claim 1, wherein the electric motor is connected to the engine via a motor mount.

10. A method of powering and starting a small engine with an electric starter, comprising:
charging a battery;
turning engine start/stop switch to run;
turning on an engine choke; and
pushing a starter button until engine starts.

11. The method of claim 10, further comprising:
if the battery is not charged, utilizing a pull start device to start the engine.

12. The method of claim 11, further comprising:
turning off the engine choke once the engine is warmed up.

13. The method of claim 12, wherein the small engine comprises two cycle/two stroke engines, such as those used in weed trimmers, leaf blowers, or chainsaws.

14. The method of claim 13, wherein the battery is rechargeable.

15. An electric starter device for two cycle/two stroke engines comprising:
an electric motor comprising a battery and an electric starter switch; and
a two cycle/two stroke engine comprising a pull start, a start/stop switch for turning on and off the engine and an engine choke switch for engaging the engine.

16. The electric starter device of claim 15, wherein the electric motor further comprises an engine crankshaft connected to the electric motor by a pulley.

17. The electric starter device of claim 16, wherein the battery is rechargeable and is contained in a housing attached at a lower handle of the two cycle/two stroke engine.

18. The electric starter device of claim 17, wherein the pull start is engaged if the battery is low or there is an electrical failure.

19. The electric starter device of claim 18, wherein the electric starter switch is positioned next to the start/stop switch beside a throttle lever of the engine.

20. The electric starter device of claim 15, wherein the two cycle/two stroke engines comprise engines such as those used in weed trimmers, leaf blowers, or chainsaws.
